(19) United States
(12) Patent Application Publication
(10) Pub. No.: US 2009/0066920 A1
(43) Pub. Date: Mar. 12, 2009

(54) PROJECTION TYPE IMAGE DISPLAY DEVICE

(75) Inventors: Shigekazu Yamagishi, Osaka (JP); Yusaku Shimaoka, Osaka (JP); Yoshimasa Fushimi, Osaka (JP); Mitsuhiro Wada, Kyoto (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka (JP)

(21) Appl. No.: 11/912,234

(22) PCT Filed: Jul. 27, 2006
(86) PCT No.: PCT/JP2006/314910

§ 371 Date: Oct. 22, 2007

(30) Foreign Application Priority Data
Sep. 12, 2005 (JP) 2005-264020

(51) Int. Cl. G03B 21/28

(52) U.S. Cl. 353/99; 353/98; 353/38

(57) ABSTRACT

A projection type image display device includes a reflector 5 having an ellipsoidal reflection surface 4 as an inner surface thereof, a light source 35 in which at least a light emitting portion 1 is substantially planar, a light distribution thereof is within ±90° with respect to a normal line perpendicular to the plane, and the light emitting portion 1 is located optically at a first focus 3 of the spheroid forming the ellipsoidal reflection surface 4 of the reflector 5, a rod integrator 8 having an entrance opening portion in which a second focus 7 of the spheroid forming the ellipsoidal reflection surface 4 of the reflector 5 is located at the entrance opening portion thereof, a light modulator 11 capable of modulating an output of transmission light in accordance with an external signal, a relay optical system 10 for transferring an image of an exit opening portion of the rod integrator 8 onto the light modulator 11, and a projection lens 15 for enlarging and projecting the image on the light modulator 11 onto a screen. Thereby, the light uptake rate to the image display apparatus of the light source having a flat light emitting surface and for emitting light in one direction of the surface can be improved so as to maximize the brightness.

### TECHNICAL FIELD

The present invention relates to a projection type image display device including a light source having a flat light emitting surface.

### BACKGROUND ART

Conventionally, in an illumination unit of a projection type image display device, generally, a high-pressure mercury lamp is employed as a light source (see, for example, Patent Document 1). This is mainly because its light emitting portion is a gap between electrodes and is considerably small (mainstream gap length: 1 to 1.5 mm), so that light easily is collected optically to the image display apparatus, and also, the light source itself has excellent light emission efficiency. However, in the case of the high-pressure mercury lamp, ultraviolet light or infrared light is generated in addition to desired visible light, leading to considerably high temperatures in a portion surrounding the light source. Also, the life span is generally about 2000 hours (10000 hours for a long-life type), so that replacement is required in the market, resulting in high running cost and the like.

To solve these problems, an attempt is being made to employ an LED (light emitting diode) element as the light source of the illumination unit of a projection type image display device (such a light source employing an LED element is referred to as an “LED light source”). Such an attempt is being made because of the following features of the LED element: ability to achieve a life of 20000 hours or more; excellent color reproducibility because of light emitting characteristics for each of R (red), G (green) and B (blue) colors provided thereto; no generation of hazardous light; and the like.

### Patent Document 1: JP H11-142780A

### DISCLOSURE OF INVENTION

### Problem to be Solved by the Invention

However, LED elements have not yet reached a point where they match high-pressure mercury-arc lamps in terms of light emission efficiency. Also, the absolute value of output thereof is small. Therefore, when an LED element is employed as the light source of the illumination unit of a projection type image display device, a sufficient brightness cannot be obtained. To overcome this problem, it inevitably is required to improve the light emission efficiency and output of an LED element itself. Also, regarding the system, it is a challenge to improve the efficiency with which light from the LED light source is taken into the image display apparatus or utilize a plurality of light sources so as to obtain a sufficient amount of light.

The present invention is achieved in view of the above-described conventional problems. An object of the present invention is to provide a projection type image display device in which a light source (e.g., an LED light source) that has a flat light emitting surface and emits light in a direction of the surface has an improved rate (light uptake rate) at which light is taken into the image display apparatus, so that the brightness is maximized and a plurality of light sources can be employed, thereby making it possible to increase the luminance.

### Means for Solving Problem

To achieve the above-described object, a first configuration of a projection type image display device according to the present invention includes a reflector having a reflection surface of a spheroid as an inner surface thereof, a light source in which at least a light emitting portion thereof is substantially planar, a light distribution thereof is within ±90° with respect to a normal line perpendicular to the plane, and the light emitting portion is located optically at a first focus of the spheroid forming the reflection surface of the reflector, a rod integrator having an entrance opening portion in which a second focus of the spheroid forming the reflection surface of the reflector is located at the entrance opening portion thereof, a light modulating device capable of modulating an output of transmission light in accordance with an external signal, a relay optical system for transferring an image of an exit opening portion of the rod integrator onto the light modulating device, and a projection optical system for enlarging and projecting the image on the light modulating device onto a screen.

Also, a second configuration of the projection type image display device of the present invention includes a reflector having a reflection surface of a paraboloid of revolution as an inner surface thereof, a light source in which at least a light emitting portion thereof is substantially planar, a light distribution thereof is within ±90° with respect to a normal line perpendicular to the plane, and the light emitting portion is located optically at a focus of the paraboloid of revolution forming the reflection surface of the reflector, a condenser lens provided in front of an exit surface of the reflector, a rod integrator having an entrance opening portion at a focus position of the condenser lens, a light modulating device capable of modulating an output of transmission light in accordance with an external signal, a relay optical system for transferring an image of an exit opening portion of the rod integrator onto the light modulating device, and a projection optical system for enlarging and projecting the image on the light modulating device onto a screen.

Also, a third configuration of the projection type image display device of the present invention includes a reflector having a reflection surface of a paraboloid of revolution as an inner surface thereof, a light source in which at least a light emitting portion thereof is substantially planar, a light distribution thereof is within ±90° with respect to a normal line perpendicular to the plane, and the light emitting portion is located optically at a focus of the paraboloid of revolution forming the reflection surface of the reflector, a lens-array integrator provided in front of an exit surface of the reflector and including a set of microlenses, a light modulating device illuminated by the lens-array integrator and capable of modulating an output of transmission light in accordance with an external signal, and a projection optical system for enlarging and projecting the image on the light modulating device onto a screen.

Also, a fourth configuration of the projection type image display device of the present invention includes a reflector having a reflection surface of a spheroid as an inner surface thereof, a light source in which at least a light emitting portion thereof is substantially planar, a light distribution thereof is within ±90° with respect to a normal line perpendicular to the plane, and the light emitting portion is located optically at a first focus of the spheroid forming the reflection surface of the reflector, a condenser lens having a focus at a position of a second focus of the spheroid forming the reflection surface of the reflector, a lens-array integrator provided in front of the condenser lens and including a set of microlenses, a light modulating device illuminated by the lens-array integrator and capable of modulating an output of transmission light in accordance with an external signal, and a projection optical system for enlarging and projecting the image on the light modulating device onto a screen.

Also, in the first to fourth configurations of the projection type image display device of the present invention, the light emitting portion of the light source preferably is inclined toward a surface vertex of the reflection surface of the reflector with reference to a center axis of rotation of the reflection surface of the reflector. Also, in this case, an angle θ between the normal line perpendicular to the plane of the light emitting portion of the light source and the center axis of rotation of the reflection surface of the reflector preferably is in the range of 60°≦θ≦90°.

Also, in the first or fourth configuration of the projection type image display device of the present invention, the center axis of rotation of the reflection surface of the reflector preferably is inclined with respect to a system axis that is an optical axis common to optical parts excluding the reflector and the light source so that a light collection angle of light from the reflector is substantially symmetric with respect to the system axis.

Also, in the second or third configuration of the projection type image display device of the present invention, the center axis of rotation of the reflection surface of the reflector preferably is shifted in parallel with a system axis that is an optical axis common to optical parts excluding the reflector and the light source so that a light collection angle of light from the reflector is substantially symmetric with respect to the system axis.

Also, in the first to fourth configurations of the projection type image display device of the present invention, a plurality of illumination units, each of which includes the reflector and the light source, preferably are provided, and the plurality of reflectors preferably are arranged symmetrically with respect to a system axis that is an optical axis common to optical parts excluding the illumination unit. Also, in this case, the plurality of reflectors preferably are arranged so that outer surfaces thereof are close to each other.

### EFFECTS OF THE INVENTION

According to the first to fourth configurations of the projection type image display device of the present invention, light from plane-emission light source having a wide emission angle can be collected efficiently and taken into the image display apparatus.

Also, in the preferable example in which the light emitting portion of the light source is inclined toward the surface vertex of the reflection surface of the reflector with reference to the center axis of rotation of the reflection surface of the reflector, the amount of light that is emitted directly toward the exit surface of the reflector is reduced, resulting in an improvement of light use efficiency.

Also, in the preferable example in which the center axis of rotation of the reflection surface of the reflector is inclined with respect to a system axis that is an optical axis common to optical parts excluding the reflector and the light source so that the light collection angle of light from the reflector is substantially symmetric with respect to the system axis, the light uptake rate to the image display apparatus can be optimized.

Also, in the preferable example (multi-lamp configuration) in which a plurality of illumination units, each of which includes the reflector and the light source, are provided, and the plurality of reflectors are arranged symmetrically with respect to a system axis that is an optical axis common to optical parts excluding the illumination unit, a light amount that cannot be obtained by a one-lamp configuration can be obtained, thereby making it possible to improve the brightness of a projected image dramatically. In particular, if the plurality of reflectors are arranged so that outer surfaces thereof are close to each other, a member (a heat sink or the like) for cooling can be provided at the back of the light source without an optical influence.

### BRIEF DESCRIPTION OF DRAWINGS

FIG. 1 is a configuration diagram showing a projection type image display device according to a first embodiment of the present invention.

FIG. 2 is a side view showing a light source used in the projection type image display device of the embodiments of the present invention.

FIG. 3 is a diagram showing an exemplary light intensity distribution (light distribution) of a light source used in the projection type image display device of the embodiments of the present invention.

FIG. 4 is a configuration diagram showing another exemplary projection type image display device according to the first embodiment of the present invention.

FIG. 5 is a configuration diagram showing still another exemplary projection type image display device according to the first embodiment of the present invention.

FIG. 6 is a configuration diagram showing even still another exemplary projection type image display device according to the first embodiment of the present invention.

FIG. 7 is a configuration diagram showing a projection type image display device according to a second embodiment of the present invention.

FIG. 8 is a configuration diagram showing a projection type image display device according to a third embodiment of the present invention.

FIG. 9 is a configuration diagram showing a projection type image display device according to a fourth embodiment of the present invention.

FIG. 10 is a configuration diagram showing a projection type image display device according to a fifth embodiment of the present invention.

FIG. 11 is a configuration diagram showing a projection type image display device according to a sixth embodiment of the present invention.

FIG. 12 is a configuration diagram showing a projection type image display device according to a seventh embodiment of the present invention.

FIG. 13 is a configuration diagram showing a projection type image display device according to an eighth embodiment of the present invention.

### BEST MODE FOR CARRYING OUT THE INVENTION

Hereinafter, the present invention will be described in more detail by way of embodiments.

### First Embodiment

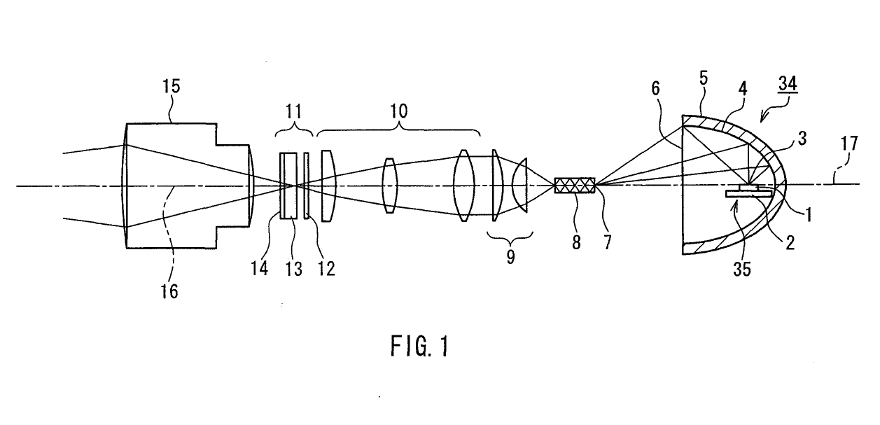

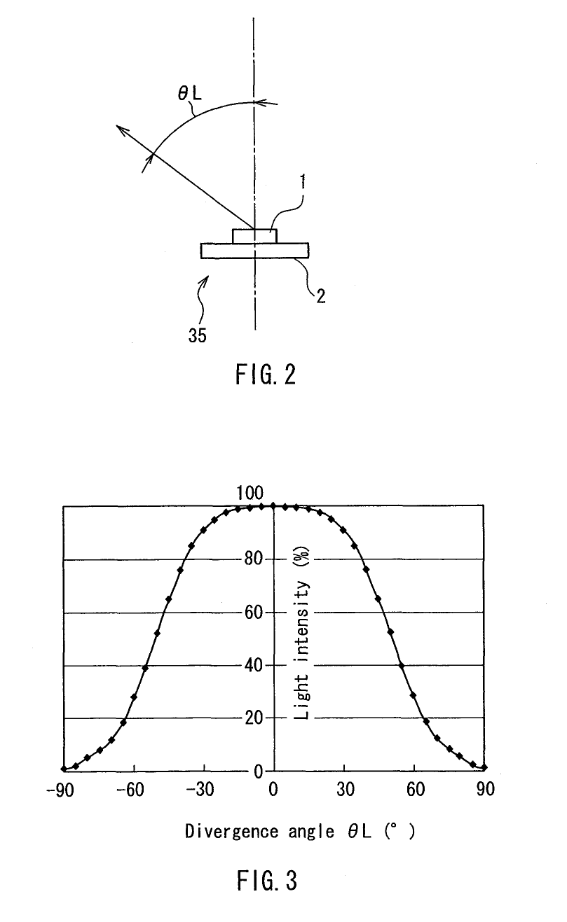

FIG. 1 is a configuration diagram showing a projection type image display device according to a first embodiment of the present invention. FIG. 2 is a side view showing a light source used in the projection type image display device.

As shown in FIG. 1, the projection type image display device of this embodiment is configured by sequentially arranging an illumination unit 34, a rod integrator 8, a condenser lens 9, a relay optical system 10, a light modulator 11 as a light modulating device, and a projection lens 15 as a projection optical system.

The illumination unit 34 includes a light source 35 and a reflector 5 having an ellipsoidal reflection surface 4 as an inner surface thereof. The light source 35, which is a solid-state light emitting source, includes a substrate 2 connected to a power supply source (not shown), and a light emitting portion 1 that is mounted on the substrate 2 and is substantially planar. The ellipsoidal reflection surface 4 of the reflector 5 is a curved surface (spheroid) that is obtained by rotating an ellipse about its major axis and dividing the resultant surface into two equal portions by a plane including the major axis. In this case, the major axis (the center axis of rotation) of the ellipse coincides with a center axis (hereinafter referred to as a “reflector axis”) 17 of the reflector 5. The reflector 5 is arranged so that a first focus 3 of the spheroid forming the ellipsoidal reflection surface 4 thereof is located on a surface (light emitting surface) of the light emitting portion 1 of the light source 35. In this case, the light source 35 is arranged so that the light emitting surface coincides with a surface including the reflector axis 17. Note that, in FIG. 1, numeral 6 indicates an opening of the reflector 5. As shown in FIG. 2, the light emitting surface of the light emitting portion 1 of the light source 35 emits light at a divergence angle of θL with respect to a normal line (light source center axis) perpendicular to the light emitting surface. FIG. 3 shows an exemplary light intensity distribution (light distribution) of the light source where the horizontal axis represents the divergence angle θL of emitted light with respect to the light source center axis, and the vertical axis represents the light intensity. As can be seen from FIG. 3, effective light is emitted within the range of −90°≦θL≦+90°. In other words, the light source 35 has a light distribution within ±90° with respect to the normal line perpendicular to the light emitting surface.

The rod integrator 8 generally is formed of glass and in the shape of hexahedron. Alternatively, an arrangement of four plane mirrors as side walls may be employed as a rod integrator. This rod integrator 8 is arranged so that a second focus 7 of the spheroid forming the ellipsoidal reflection surface 4 of the reflector 5 is located at an entrance opening portion thereof.

The condenser lens 9 is arranged so that a focus position thereof is located at an exit opening portion of the rod integrator 8. The condenser lens 9 converts light from the rod integrator 8 into substantially parallel light.

The relay optical system 10, which includes a plurality of lenses, efficiently can guide light from the condenser lens 9 to the light modulator 11. The relay optical system 10 transfers an image of the exit opening portion of the rod integrator 8 onto the light modulator 11.

The light modulator 11, which is provided at an illumination position of the relay optical system 10, includes a transmission liquid crystal panel 13 on which an image is formed, an entrance polarizing plate 12 provided on the light incident side (entrance) of the liquid crystal panel 13, and an exit polarizing plate 14 provided on the light emitting side (exit) of the liquid crystal panel 13. The liquid crystal panel 13, which is formed of cells that can be controlled separately to change a state of liquid crystal in accordance with an external signal and that are arranged in a two-dimensional manner, can modulate an output of transmitted light in accordance with an external signal. The entrance polarizing plate 12 transmits only the part of incident light polarized in one direction. The exit polarizing plate 14 transmits light polarized in a direction of the transmission axis and absorbs light polarized in a direction orthogonal to the transmission axis. The detailed operation of the light modulator 11 is not required to describe the present invention and will not be described.

The projection lens 15, which includes a plurality of lenses, enlarges and projects an image formed on the liquid crystal panel 13 of the light modulator 11 onto a screen (not shown).

In FIG. 1, numeral 16 indicates a system axis that is an optical axis common to optical parts including the rod integrator 8, the condenser lens 9, the relay optical system 10, the light modulator 11, and the projection lens 15 other than the illumination unit 34. In the projection type image display device of FIG. 1, the system axis 16 coincides with the reflector axis 17. Hereinafter, an operation of the thus-configured projection type image display device will be described.

Light emitted from the light source 35 whose light emitting surface is located at the first focus 3 of the spheroid forming the ellipsoidal reflection surface 4 of the reflector 5, is reflected from the ellipsoidal reflection surface 4 of the reflector 5, and is emitted from the opening 6 of the reflector 5. The light emitted from the opening 6 of the reflector 5 is collected to the second focus 7 of the spheroid forming the ellipsoidal reflection surface 4 of the reflector 5 to enter the rod integrator 8 having the entrance opening portion at the position of the second focus 7. The light is reflected repeatedly in the rod integrator 8 before entering the condenser lens 9 having a focus position at the exit opening portion of the rod integrator 8, resulting in substantially parallel light, which then enters the relay optical system 10. The light from the condenser lens 9 is guided efficiently by the relay optical system 10 to the light modulator 11, so that an image is formed on the liquid crystal panel 13 of the light modulator 11. This image is enlarged and projected onto a screen by the projection lens 15.

According to the projection type image display device of this embodiment, by providing the above-described configuration, light from the light emitting portion 1 of the light source 35 can be collected even when it has a divergence angle θL close to 90°, except for light emitted directly toward the opening 6 of the reflector 5. Therefore, light from the light emitting portion 1 of the light source 35 can be used effectively in the condenser lens 9 and thereafter unless the light is limited by the F number (Fno) and the amount of available light determined by an effective area through which a light beam is passed. In other words, according to the projection type image display device of this embodiment, light from the light emitting portion 1 of the light source 35 efficiently can be taken into the image display apparatus.

Note that, when a cover glass for surface protection or the like is provided around the light emitting portion 1 of the light source 35, the light source 35 is desirably shifted and adjusted while maintaining the light emitting surface in parallel with a plane including the reflector axis 17 so that the position of the first focus 3 of the spheroid forming the ellipsoidal reflection surface 4 of the reflector 5 is not optically deviated from the light emitting portion 1. Also, for example, when an optical member for collecting light is integrated with the light source 35, a similar adjustment desirably is performed so that the position of the first focus 3 of the spheroid forming the ellipsoidal reflection surface 4 of the reflector 5 is not optically deviated from the light emitting portion 1.

Also, although an image obtained by the projection type image display device of this embodiment is displayed in a single color (monochrome display), color display also can be performed if the following configuration is employed. For example, the parts including from the light emitting portion 1 of the light source 35 to the condenser lens 9 are prepared for each of R (red), G (green) and B (blue) colors, and a color combining optical system including a dichroic mirror or the like is provided between the condenser lens 9 and the relay lens 10 where substantially parallel light is obtained. Light emission is shifted temporally between each color, and in synchronization with this, the colors are combined to form an image on the liquid crystal panel 13, thereby making it possible to provide color display. Alternatively, the parts including from the light emitting portion 1 of the light source 35 to the light modulator 11 are prepared for each of red, green and blue colors, and the above-described color combining optical system is provided between the light modulator 11 and the projection lens 15, thereby making it possible to provide color display. It readily would be contemplated by those skilled in the art that, when liquid crystal is used as the light modulator 11 as in this embodiment, a polarized light conversion system for converting natural light from the light source 35 into light polarized in one direction or an integrator optical system for achieving uniform illumination can be introduced.

Also, although the transmission liquid crystal panel 13 is employed in the light modulator 11 in this embodiment, if the optical system from the relay optical system 10 to the projection lens 15 is optimized, a DMD (Digital Micro-Mirror Device) in which micro-movable mirrors are arranged in a two-dimensional manner or a reflection liquid crystal panel may be employed in the light modulator 11.

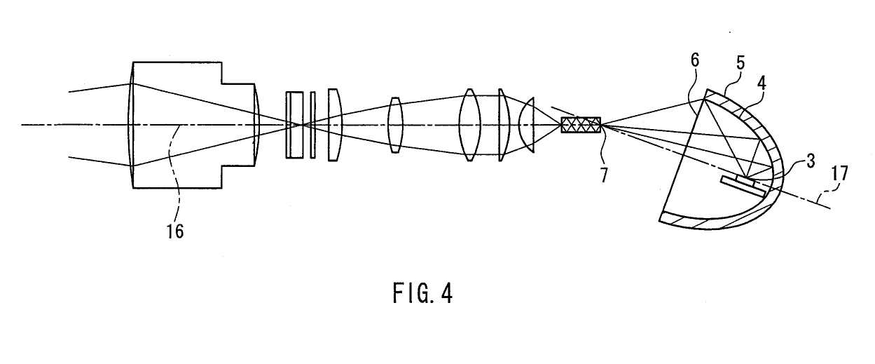

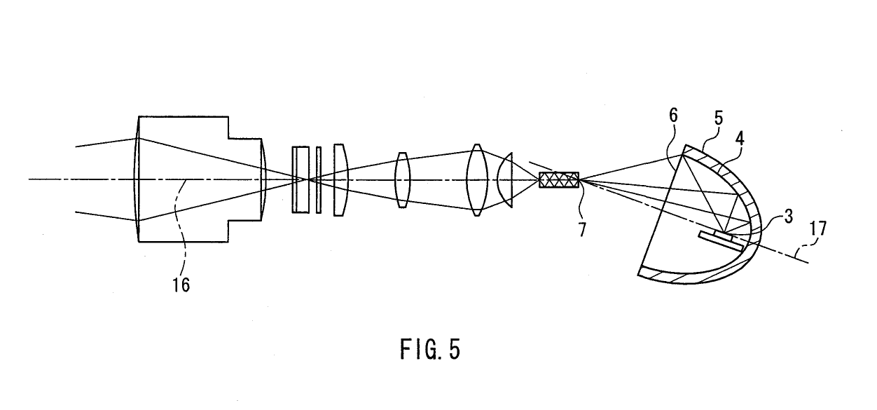

Also, it has been assumed in this embodiment that the reflector axis 17 passing through the first and second focuses 3 and 7 of the spheroid forming the ellipsoidal reflection surface 4 of the reflector 5, coincides with the system axis 16. In this case, light from the light emitting portion 1 of the light source 35 efficiently can be taken into the image display apparatus, though there is a slight problem with uniform illumination to the light modulator 11. Specifically, the light source 35 is arranged so that the light emitting surface of the light emitting portion 1 coincides with a plane including the reflector axis 17, and light from the light emitting portion 1 of the light source 35 is reflected from only a half of the ellipsoidal reflection surface 4 of the reflector 5, so that the light collection angle of light from the opening 6 of the reflector 5 is asymmetric with respect to the system axis 16 (see FIG. 1). Therefore, it is difficult for light from the opening 6 of the reflector 5 to be uniform in the rod integrator 8, so that it is difficult to obtain the uniformity of illumination to the light modulator 11. Therefore, as shown in FIGS. 4 and 5, the reflector axis 17 desirably is inclined with respect to the system axis 16 with reference to the second focus 7 so that the light collection angle of light from the opening 6 of the reflector 5 becomes symmetric with respect to the system axis 16. Thereby, the light uptake rate to the image display apparatus can be optimized, and the uniform illumination to the light modulator 11 can be achieved. Note that, when the intensity distribution (light distribution) of the light source 35 is not symmetric, maximum light use efficiency may be obtained even if the symmetry with respect to the system axis 16 of the light collection angle of light from the opening 6 of the reflector 5 is slightly broken.

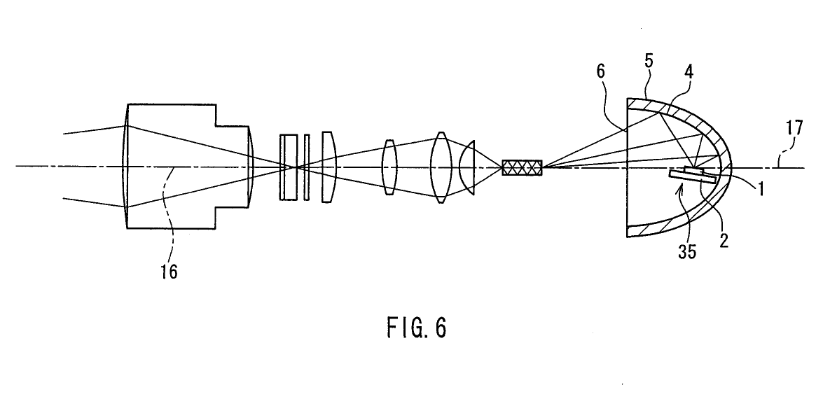

Also, in this embodiment, the light source 35 is arranged so that the surface (light emitting surface) of the light emitting portion 1 coincides with a plane including the reflector axis 17. Alternatively, as shown in FIG. 6, the light emitting surface may be inclined toward the surface vertex of the ellipsoidal reflection surface 4 of the reflector 5, so that light emitted directly toward the opening 6 of the reflector 5 is reduced, thereby improving the light use efficiency. Note that, if the light emitting surface of the light source 35 is excessively inclined, light reflected from the surface vertex side of the ellipsoidal reflection surface 4 is blocked by the light emitting portion 1 or the substrate 2. Therefore, an optimal inclined angle desirably is determined based on the balance between the amount of light that is otherwise emitted directly toward the opening 6 of the reflector 5 and the amount of light that is interrupted by the light emitting portion 1 or the substrate 2, in view of the light distribution of FIG. 3. An angle θ between the reflector axis 17 and the normal line perpendicular to the surface (light emitting surface) of the light emitting portion 1 of the light source 35 is desirably within the range of 60°≦θ≦90°.

Also, although the condenser lens 9 and the relay optical system 10 are clearly separated in this embodiment, both of them may be integrated together as shown in FIGS. 5 and 6.

### Second Embodiment

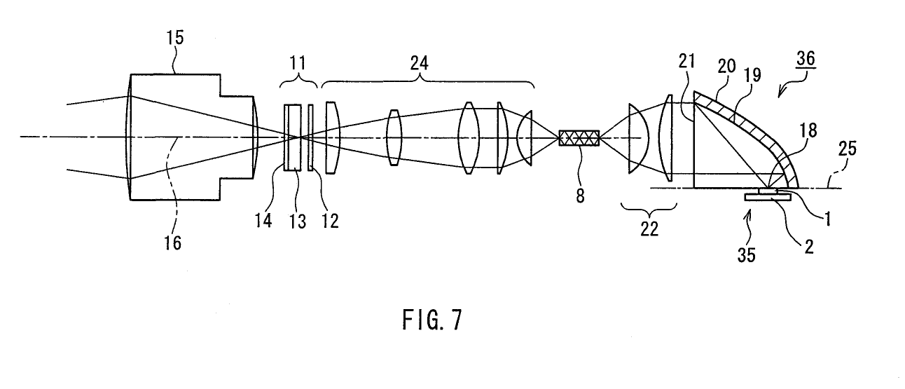

FIG. 7 is a configuration diagram showing a projection type image display device according to a second embodiment of the present invention.

As shown in FIG. 7, the projection type image display device of this embodiment is configured by sequentially arranging an illumination unit 36, a condenser lens 22, a rod integrator 8, a relay optical system 24, a light modulator 11 as a light modulating device, and a projection lens 15 as a projection optical system. In FIG. 7, numeral 16 indicates a system axis that is an optical axis common to optical parts including the condenser lens 22, the rod integrator 8, the relay optical system 24, the light modulator 11, and the projection lens 15 other than the illumination unit 36. Note that the rod integrator 8, the light modulator 11, and the projection lens 15 are the same as those described in the first embodiment and will not be described in detail.

The illumination unit 36 includes a light source 35 and a reflector 20 having a reflection surface 19 that is a paraboloid of revolution as an inner surface thereof. The light source 35, which is a solid-state light emitting source as in the first embodiment, includes a substrate 2 connected to a power supply source (not shown), and a light emitting portion 1 that is mounted on the substrate 2 and is substantially planar. The reflector 20 is arranged so that a focus 18 of the paraboloid of revolution forming the reflection surface 19 thereof is located on a surface (light emitting surface) of the light emitting portion 1 of the light source 35. In this case, the light source 35 is arranged so that the light emitting surface coincides with a plane including a center axis of rotation (hereinafter referred to as a “reflector axis”) 25 of the paraboloid of revolution. Thereby, light from the light emitting surface of the light emitting portion 1 of the light source 35 is reflected, as light that is in parallel with the reflector axis 25, from the reflection surface 19 of the reflector 20, and is emitted from an opening 21 of the reflector 20.

The condenser lens 22 is provided in front of the opening 21 (exit surface) of the reflector 20, and collects light from the opening 21 of the reflector 20 to an entrance opening portion of the rod integrator 8 that is provided at a focus position of the condenser lens 22.

The relay optical system 24, which includes a combination of the condenser lens 9 and the relay optical system 10 that are shown in FIG. 1 of the first embodiment, is arranged so that a focus position thereof is located at an exit opening portion of the rod integrator 8. The relay optical system 24 efficiently guides light from the rod integrator 8 to the light modulator 11, so that an image of the exit opening portion of the rod integrator 8 is transferred onto the light modulator 11.

Hereinafter, an operation of the thus-configured projection type image display device will be described.

Light emitted from the light source 35 whose light emitting surface is located at the focus 18 of the paraboloid of revolution forming the reflection surface 19 of the reflector 20, is reflected from the reflection surface 19 of the reflector 20, and is emitted from the opening 21 of the reflector 20 as light that is substantially in parallel with the reflector axis 25. The light emitted from the opening 21 of the reflector 20 is collected by the condenser lens 22 to the entrance opening portion of the rod integrator 8 to enter the rod integrator 8. The light repeatedly is reflected in the rod integrator 8 before entering the relay optical system 10 whose focus position is located at the exit opening portion of the rod integrator 8. The light from the rod integrator 8 is guided efficiently to the light modulator 11 by the relay optical system 10, so that an image is formed on the liquid crystal panel 13 of the light modulator 11. The image is enlarged and projected onto a screen by the projection lens 15.

According to the projection type image display device of this embodiment, by providing the above-described configuration, light from the light emitting portion 1 of the light source 35 can be collected even when the light has a divergence angle θL close to 90°, except for light emitted directly toward the opening 21 of the reflector 20, as in the first embodiment. Therefore, light from the light emitting portion 1 of the light source 35 can be used effectively in the condenser lens 22 and thereafter unless the light is limited by the F number (Fno) and the amount of available light determined by an effective area through which a light beam is passed. In other words, according to the projection type image display device of this embodiment, light from the light emitting portion 1 of the light source 35 efficiently can be taken into the image display apparatus.

Note that, also in the projection type image display device of this embodiment, when a cover glass for surface protection or the like is provided around the light emitting portion 1 of the light source 35, the light source 35 is desirably shifted and adjusted while maintaining the light emitting surface in parallel with a plane including the reflector axis 25 so that the position of the focus 18 of the paraboloid of revolution forming the reflection surface 19 of the reflector 20 is not optically deviated from the light emitting portion 1. Also, for example, when an optical member for collecting light is integrated with the light source 35, a similar adjustment is desirably performed so that the position of the focus 18 of the paraboloid of revolution forming the reflection surface 19 of the reflector 20 is not optically deviated from the light emitting portion 1.

Also, although an image obtained by the projection type image display device of this embodiment is displayed in a single color (monochrome display), color display also can be performed if the following configuration is employed. For example, the parts including from the light emitting portion 1 of the light source 35 to the reflector 20 are prepared for each of red, green and blue colors, and a color combining optical system including a dichroic mirror or the like is provided between the opening 21 of the reflector 20 and the condenser lens 22 where substantially parallel light is obtained. Light emission is shifted temporally between each color, and in synchronization with this, the colors are combined to form an image on the liquid crystal panel 13, thereby making it possible to provide color display. Alternatively, the parts including from the light emitting portion 1 of the light source 35 to the light modulator 11 are prepared for each of red, green and blue colors, and the above-described color combining optical system is provided between the light modulator 11 and the projection lens 15, thereby making it possible to provide color display. Note that it readily would be contemplated by those skilled in the art that a function of converting into polarized light can be introduced as in the first embodiment.

As shown in FIG. 7, the reflector axis 25 desirably is shifted in parallel with the system axis 16 so that the light collection angle of light from the opening 21 of the reflector 20 becomes symmetric with respect to the system axis 16. Thereby, as in the first embodiment, the light uptake rate to the image display apparatus can be optimized, and the uniform illumination to the light modulator 11 can be achieved. Note that, when the intensity distribution (light distribution) of the light source 35 is not symmetric, maximum light use efficiency may be obtained even if the symmetry with respect to the system axis 16 of the light collection angle of light from the opening 21 of the reflector 20 is slightly broken. Therefore, the shift amount of the reflector axis 25 needs to be optimized, depending on the individual configuration.

Further, also in the projection type image display device of this embodiment, by inclining a surface (light emitting surface) of the light emitting portion 1 of the light source 35 toward the surface vertex of the reflection surface 19 (paraboloid of revolution) on the reflector axis 25, light emitted directly toward the opening 21 of the reflector 20 is reduced, resulting in an improvement in light use efficiency.

### Third Embodiment

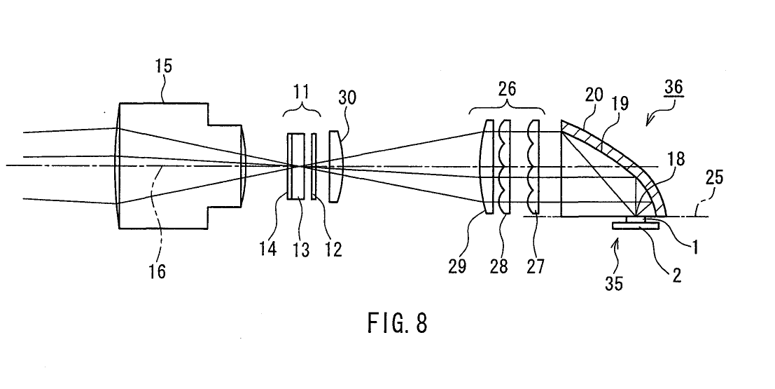

FIG. 8 is a configuration diagram showing a projection type image display device according to a third embodiment of the present invention. As shown in FIG. 8, the projection type image display device of this embodiment is configured by sequentially arranging an illumination unit 36, a lens-array integrator 26, a field lens 30, a light modulator 11 as a light modulating device, and a projection lens 15 as a projection optical system. In FIG. 8, numeral 16 indicates a system axis that is an optical axis common to optical parts including the lens-array integrator 26, the field lens 30, the light modulator 11, and the projection lens 15 other than the illumination unit 36. Note that the illumination unit 36 is the same as that of the second embodiment and will not be described in detail. Also, the light modulator 11 and the projection lens 15 are the same as those of the first embodiment and will not be described in detail.

The lens-array integrator 26, which is provided in front of the opening 21 (exit surface) of the reflector 20, includes a first lens array 27 that is a set of microlenses, a second lens array 28 that is in one-to-one correspondence with the microlenses of the first lens array 27, and a light collecting lens 29. The lens-array integrator 26 divides light emitted from the opening 21 of the reflector 20 into a plurality of pieces of partial light, superimposes the pieces of partial light together, and illuminates the light modulator 11 with the resultant light.

Hereinafter, an operation of the thus-configured projection type image display device will be described.

Light emitted from the light source 35 whose light emitting surface is located at the focus 18 of the paraboloid of revolution forming the reflection surface 19 of the reflector 20, is reflected from the reflection surface 19 of the reflector 20, and is emitted from the opening 21 of the reflector 20 as light that is substantially in parallel with the reflector axis 25. The light emitted from the opening 21 of the reflector 20 enters the lens-array integrator 26 that is provided in front of the reflector 20. The light from the lens-array integrator 26 is guided via the field lens 30 to the light modulator 11, so that an image is formed on the liquid crystal panel 13 of the light modulator 11. The image is enlarged and projected onto a screen by the projection lens 15.

According to the projection type image display device of this embodiment, by providing the above-described configuration, light from the light emitting portion 1 of the light source 35 can be collected even when the light has a divergence angle θL close to 90°, except for light emitted directly toward the opening 21 of the reflector 20, as in the second embodiment. Therefore, light from the light emitting portion 1 of the light source 35 can be used effectively in the lens-array integrator 26 and thereafter unless the light is limited by the F number (Fno) and the amount of available light determined by an effective area through which a light beam is passed. In other words, according to the projection type image display device of this embodiment, light from the light emitting portion 1 of the light source 35 can be taken efficiently into the image display apparatus.

Also, although an image obtained by the projection type image display device of this embodiment is displayed in a single color (monochrome display), color display can also be performed if the following configuration is employed. For example, the parts including from the light emitting portion 1 of the light source 35 to the reflector 20 are prepared for each of red, green and blue colors, and a color combining optical system including a dichroic mirror or the like is provided between the opening 21 of the reflector 20 and the lens-array integrator 26 where substantially parallel light is obtained. Light emission is shifted temporally between each color, and in synchronization with this, the colors are combined to form an image on the liquid crystal panel 13, thereby making it possible to provide color display. Alternatively, the parts including from the light emitting portion 1 of the light source 35 to the light modulator 11 are prepared for each of red, green and blue colors, and the above-described color combining optical system is provided between the light modulator 11 and the projection lens 15, thereby making it possible to provide color display. Note that it would be readily contemplated by those skilled in the art that a function of converting into polarized light can be introduced as in the first and second embodiments.

Here, if the shape of the reflection surface of the reflector is not a paraboloid of revolution, but has a long interfocal distance and is substantially a paraboloid of revolution, and light emitted from the opening of the reflector is substantially parallel light, a similar configuration can be employed (the same is true of the second embodiment). It readily would be contemplated by those skilled in the art that, when liquid crystal is used as the light modulator 11 as in this embodiment, a polarized light conversion system for converting natural light from the light source 35 into light polarized in one direction can be introduced.

As shown in FIG. 8, the reflector axis 25 desirably is shifted in parallel with the system axis 16 so that the light collection angle of light from the opening 21 of the reflector 20 becomes symmetric with respect to the system axis 16. Here, “symmetric” means that the numerical aperture (NA) is symmetric as viewed from the lens-array integrator 26. Note that, when the intensity distribution (light distribution) of the light source 35 is not symmetric, maximum light use efficiency may be obtained even if the symmetry with respect to the system axis 16 of the light collection angle of light from the opening 21 of the reflector 20 is slightly broken. Therefore, the shift amount of the reflector axis 25 needs to be optimized, depending on the individual configuration.

### Fourth Embodiment

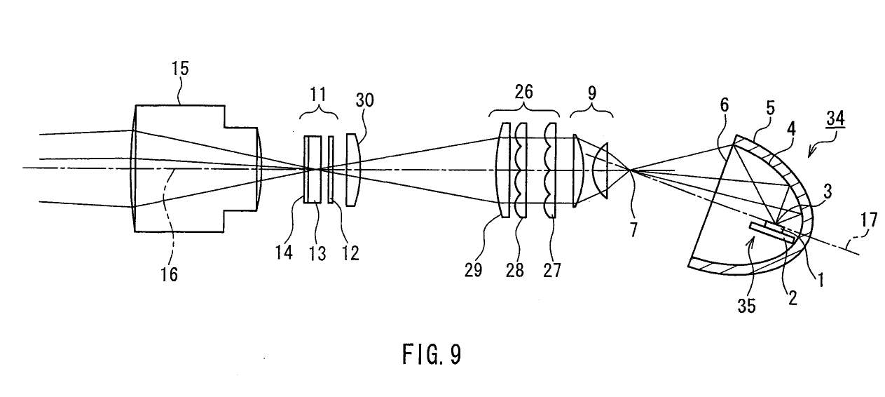

FIG. 9 is a configuration diagram showing a projection type image display device according to a fourth embodiment of the present invention.

As shown in FIG. 9, the projection type image display device of this embodiment is configured by sequentially arranging an illumination unit 34, a condenser lens 9, a lens-array integrator 26, a field lens 30, a light modulator 11 as a light modulating device, and a projection lens 15 as a projection optical system. In FIG. 9, numeral 16 indicates a system axis that is an optical axis common to optical parts including the condenser lens 9, the lens-array integrator 26, the field lens 30, the light modulator 11, and the projection lens 15 other than the illumination unit 34, and numeral 17 indicates a reflector axis. Note that the illumination unit 34, the condenser lens 9, the light modulator 11, and the projection lens 15 are the same as those of the first embodiment and will not be described in detail. Also, the lens-array integrator 26 and the field lens 30 are the same as those of the third embodiment and will not be described in detail.

The condenser lens 9 is arranged so as to have a focus at the position of the second focus 7 of the spheroid forming the ellipsoidal reflection surface 4 of the reflector 5.

Hereinafter, an operation of the thus-configured projection type image display device will be described.

Light emitted from the light source 35 whose light emitting surface is located at the first focus 3 of the spheroid forming the ellipsoidal reflection surface 4 of the reflector 5, is reflected from the ellipsoidal reflection surface 4 of the reflector 5, and is emitted from the opening 6 of the reflector 5. The light emitted from the opening 6 of the reflector 5 is collected at the second focus 7 of the spheroid forming the ellipsoidal reflection surface 4 of the reflector 5 to enter the condenser lens 9 having a focus position at the second focus 7, resulting in substantially parallel light, which enters the lens-array integrator 26. The light from the lens-array integrator 26 is guided via the field lens 30 to the light modulator 11, so that an image is formed on the liquid crystal panel 13 of the light modulator 11. This image is enlarged and projected onto a screen by the projection lens 15.

According to the projection type image display device of this embodiment, by providing the above-described configuration, light from the light emitting portion 1 of the light source 35 can be collected even when the light has a divergence angle θL close to 90°, except for light emitted directly toward the opening 6 of the reflector 5. Therefore, light from the light source 35 can be used effectively in the condenser lens 9 and thereafter unless the light is limited by the F number (Fno) and the amount of available light determined by an effective area through which a light beam is passed. In other words, according to the projection type image display device of this embodiment, light from the light emitting portion 1 of the light source 35 can be efficiently taken into the image display apparatus.

Although an image obtained by the projection type image display device of this embodiment is displayed in a single color (monochrome display), color display also can be performed if the following configuration is employed. For example, the parts including from the light emitting portion 1 of the light source 35 to the condenser lens 9 are prepared for each of red, green and blue colors, and a color combining optical system including a dichroic mirror or the like is provided between the condenser lens 9 and the lens-array integrator 26 where substantially parallel light is obtained. Light emission is shifted temporally between each color, and in synchronization with this, the colors are combined to form an image on the liquid crystal panel 13, thereby making it possible to provide color display. Alternatively, the parts including from the light emitting portion 1 of the light source 35 to the light modulator 11 are prepared for each of red, green and blue colors, and the above-described color combining optical system is provided between the light modulator 11 and the projection lens 15, thereby making it possible to provide color display. It readily would be contemplated by those skilled in the art that, when liquid crystal is used as the light modulator 11 as in this embodiment, a polarized light conversion system for converting natural light from the light source 35 into light polarized in one direction, or an integrator optical system for achieving uniform illumination can be introduced.

Also, as shown in FIG. 9, the reflector axis 17 desirably is inclined with respect to the system axis 16 with reference to the second focus 7 so that the light collection angle of light from the opening 6 of the reflector 5 becomes symmetric with respect to the system axis 16. Note that, when the intensity distribution (light distribution) of the light source 35 is not symmetric, maximum light use efficiency may be obtained even if the symmetry with respect to the system axis 16 of the light collection angle of light from the opening 6 of the reflector 5 is slightly broken. Therefore, the inclined amount of the reflector axis 17 needs to be optimized, depending on the individual configuration.

Also, by inclining a surface (light emitting surface) of the light emitting portion 1 of the light source 35 toward the surface vertex of the ellipsoidal reflection surface 4 of the reflector 5 on the reflector axis 17, light emitted directly toward the opening 6 of the reflector 5 is reduced, resulting in an improvement in light use efficiency, as in the other embodiments.

### Fifth Embodiment

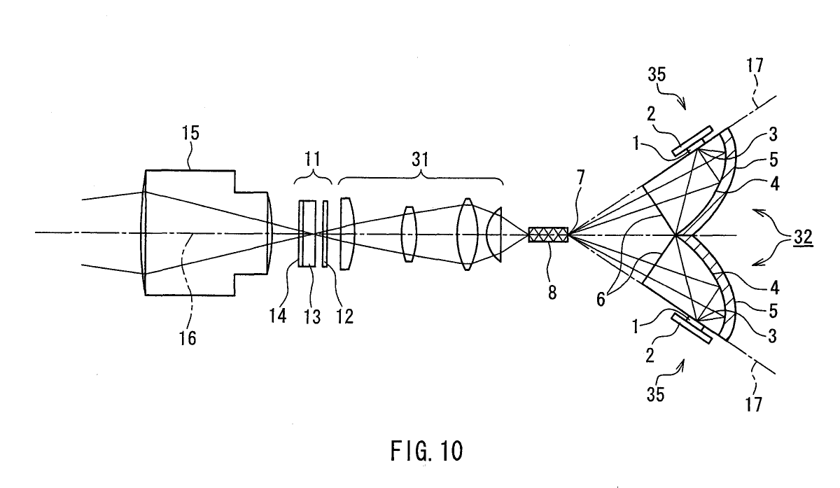

FIG. 10 is a configuration diagram showing a projection type image display device according to a fifth embodiment of the present invention.

As shown in FIG. 10, the projection type image display device of this embodiment is configured by sequentially arranging an illumination unit 32, a rod integrator 8, a relay optical system 31, a light modulator 11 as a light modulating device, and a projection lens 15 as a projection optical system. In FIG. 10, numeral 16 indicates a system axis that is an optical axis common to optical parts including the rod integrator 8, the relay optical system 31, the light modulator 11, and the projection lens 15 other than the illumination unit 32. Note that the rod integrator 8, the light modulator 11, and the projection lens 15 are the same as those of the first embodiment and will not be described in detail.

The illumination unit 32 has a two-lamp configuration. Specifically, the illumination unit 32 includes two sets of a reflector 5 having an ellipsoidal reflection surface 4 as an inner surface thereof and a light source 35 having a light emitting portion 1 whose surface (light emitting surface) is located at a first focus 3 of a spheroid forming the ellipsoidal reflection surface 4 of the reflector 5. The sets are arranged symmetrically with respect to the system axis 16 so that outer surfaces of the reflectors 5 are close to each other. The rod integrator 8 is arranged so that the second focus 7 of each spheroid forming the ellipsoidal reflection surface 4 of the reflector 5 is located at an entrance opening portion thereof. Note that, even if the second focus 7 of one spheroid forming the ellipsoidal reflection surface 4 of the reflector 5 is slightly deviated from that of the other spheroid, no problem arises as long as light effectively enters the entrance opening portion of the rod integrator 8. Also, instead of the configuration of FIG. 10, the sets can be arranged so that the reflector axes 17 of the reflectors 5 are close to each other. Note that, in the case of a solid-state light emitting source, a heat radiating mechanism, such as a heat sink or the like, generally is provided at the back of the substrate 2, and therefore, the configuration of FIG. 10 is more preferable since a spatial margin is provided at the back of the substrate 2. Similarly, a larger number of lamps can be used.

The relay optical system 31 is the same as the arrangement of the first embodiment shown in FIG. 5 in which a condenser lens and a relay optical system are integrated together. The relay optical system 31 is arranged so that a focus position thereof is located at the exit opening portion of the rod integrator 8.

According to the projection type image display device of this embodiment (two-lamp configuration), a light amount that cannot be obtained by the one-lamp configuration can be obtained, thereby making it possible to improve the brightness of a projected image dramatically. Note that the multi-lamp configuration is applicable to the projection type image display device of the fourth embodiment by employing the above-described configuration.

### Sixth Embodiment

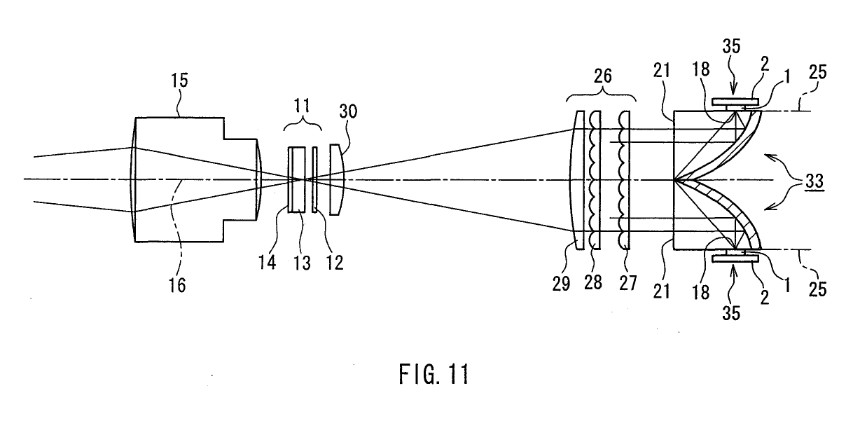

FIG. 11 is a configuration diagram showing a projection type image display device according to a sixth embodiment of the present invention.

As shown in FIG. 11, the projection type image display device of this embodiment is configured by sequentially arranging an illumination unit 33, a lens-array integrator 26, a field lens 30, a light modulator 11 as a light modulating device, and a projection lens 15 as a projection optical system. In FIG. 11, numeral 16 indicates a system axis that is an optical axis common to optical parts including the lens-array integrator 26, the field lens 30, the light modulator 11, and the projection lens 15 other than the illumination unit 33. Note that the lens-array integrator 26 and the field lens 30 are the same as those of the third embodiment and will not be described in detail. Also, the light modulator 11 and the projection lens 15 are the same as those of the first embodiment and will not be described in detail.

The illumination unit 33 has a two-lamp configuration. Specifically, the illumination unit 33 includes two sets of a reflector 20 having a reflection surface 19 that is a paraboloid of revolution as an inner surface thereof, and a light source 35 having a light emitting portion 1 whose surface (light emitting surface) is located at a focus 18 of a paraboloid of revolution forming the reflection surface 19 of the reflector 20. These sets are arranged symmetrically with respect to the system axis 16 so that outer surfaces of the reflectors 20 are close to each other, and each reflector axis 25 is in parallel with the system axis 16. Note that, even if the reflector axis 25 and the system axis 16 are slightly deviated from their parallel state, no problem arises as long as the deviation is within a range that can be handled by the lens-array integrator 26. Also, instead of the configuration of FIG. 11, the sets can be arranged so that the reflector axes 25 of the reflectors 20 may be close to each other. Note that, in the case of a solid-state light emitting source, a heat radiating mechanism, such as a heat sink or the like, is generally provided at the back of the substrate 2, and therefore, the configuration of FIG. 11 is more preferable since a spatial margin is provided at the back of the substrate 2. Similarly, a larger number of lamps can be used.

According to the projection type image display device of this embodiment (two-lamp configuration), a light amount that cannot be obtained by the one-lamp configuration can be obtained, thereby making it possible to improve the brightness of a projected image dramatically.

Note that the multi-lamp configuration is applicable to the projection type image display device of the third embodiment by employing the above-described configuration.

### Seventh Embodiment

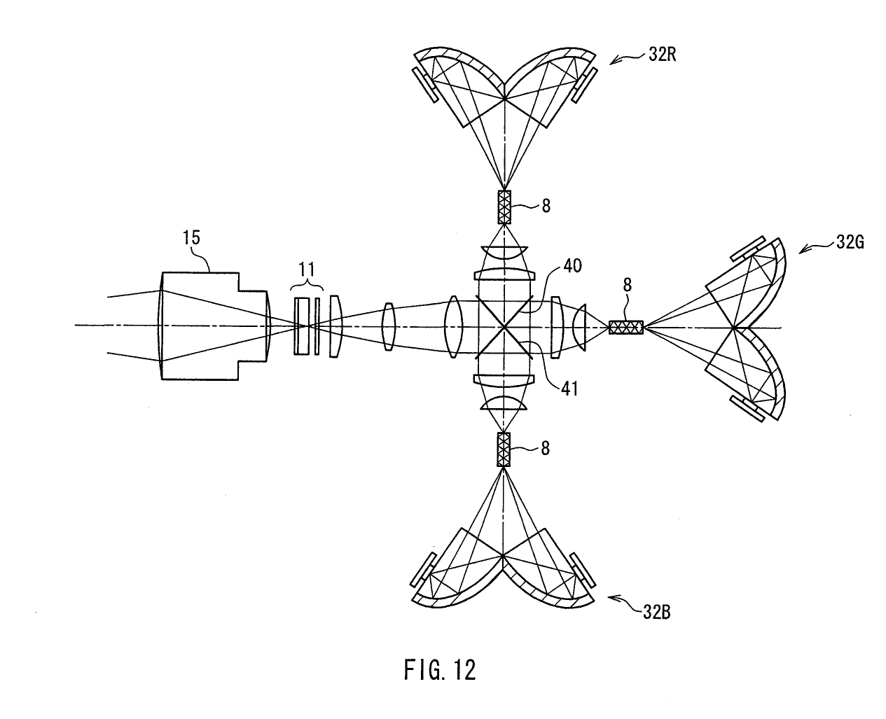

FIG. 12 is a configuration diagram showing a projection type image display device according to a seventh embodiment of the present invention.

The projection type image display device of FIG. 12 is configured to support color display by applying the projection type image display device (FIG. 10) of the fifth embodiment. Here, light beams from illumination units 32R, 32G and 32B prepared for respective colors R (red), G (green) and B (blue), are combined using respective dichroic mirrors. Light from the illumination unit 32R is reflected from a red reflecting dichroic mirror 40, light from the illumination unit 32B is reflected from a blue reflecting dichroic mirror 41, and light from the illumination unit 32G is transmitted through the red reflecting dichroic mirror 40 and the blue reflecting dichroic mirror 41, thereby making it possible to combine light beams from the illumination units 32R, 32G and 32B. A display operation has been described in the first to fourth embodiments and will not be described. Note that a means for combining light beams from the illumination units 32R, 32G and 32B is not necessarily limited to a dichroic mirror, and can be, for example, a prism or a diffraction grating.

### Eighth Embodiment

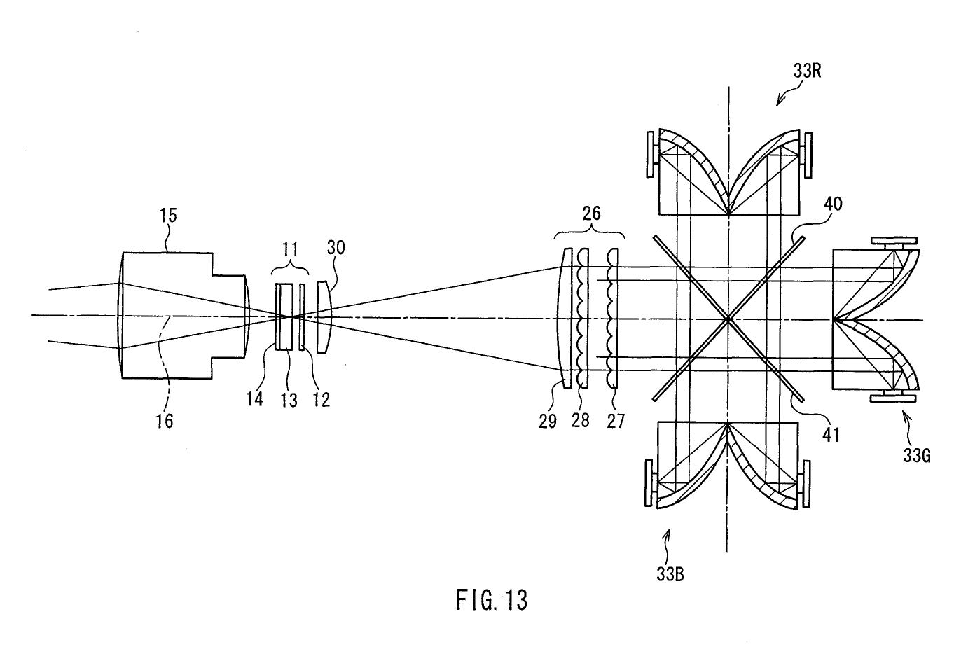

FIG. 13 is a configuration diagram showing a projection type image display device according to an eighth embodiment of the present invention. The projection type image display device of FIG. 13 is configured to support color display by applying the projection type image display device (FIG. 11) of the sixth embodiment. Here, R (red), G (green) and B (blue), are combined using respective dichroic mirrors. Light from an illumination unit 33R is reflected from a red reflecting dichroic mirror 40, light from an illumination unit 33B is reflected from a blue reflecting dichroic mirror 41, and light from an illumination unit 33G is transmitted through the red reflecting dichroic mirror 40 and the blue reflecting dichroic mirror 41, thereby making it possible to combine light beams from the illumination units 33R, 33G and 33B. A display operation has been described in the first to fourth embodiments and will not be described.

Note that a means for combining light beams from the illumination units 33R, 33G and 33B is not necessarily limited to a dichroic mirror, and can be, for example, a prism or a diffraction grating.

### INDUSTRIAL APPLICABILITY

As described above, according to the present invention, light from a plane-emission light source having a wide emission angle can be efficiently collected and taken into an image display apparatus. Therefore, the present invention is useful for a projection type image display device requiring sufficient light intensity.

1. A projection type image display device comprising:
a reflector having a reflection surface of a spheroid as an inner surface thereof;
a light source, wherein at least a light emitting portion thereof is substantially planar, a light distribution thereof is within ±90° with respect to a normal line perpendicular to the plane, and the light emitting portion is located optically at a first focus of the spheroid forming the reflection surface of the reflector;
a rod integrator having an entrance opening portion, wherein a second focus of the spheroid forming the reflection surface of the reflector is located at the entrance opening portion thereof;
a light modulating device capable of modulating an output of transmission light in accordance with an external signal;
a relay optical system for transferring an image of an exit opening portion of the rod integrator onto the light modulating device; and
a projection optical system for enlarging and projecting the image on the light modulating device onto a screen.

2. A projection type image display device comprising:
a reflector having a reflection surface of a paraboloid of revolution as an inner surface thereof;
a light source, wherein at least a light emitting portion thereof is substantially planar, a light distribution thereof is within ±90° with respect to a normal line perpendicular to the plane, and the light emitting portion is located optically at a focus of the paraboloid of revolution forming the reflection surface of the reflector;
a condenser lens provided in front of an exit surface of the reflector;
a rod integrator having an entrance opening portion at a focus position of the condenser lens;
a light modulating device capable of modulating an output of transmission light in accordance with an external signal;
a relay optical system for transferring an image of an exit opening portion of the rod integrator onto the light modulating device; and
a projection optical system for enlarging and projecting the image on the light modulating device onto a screen.

3. A projection type image display device comprising:
a reflector having a reflection surface of a paraboloid of revolution as an inner surface thereof;
a light source, wherein at least a light emitting portion thereof is substantially planar, a light distribution thereof is within ±90° with respect to a normal line perpendicular to the plane, and the light emitting portion is located optically at a focus of the paraboloid of revolution forming the reflection surface of the reflector;
a lens-array integrator provided in front of an exit surface of the reflector and including a set of microlenses;
a light modulating device illuminated by the lens-array integrator and capable of modulating an output of transmission light in accordance with an external signal; and
a projection optical system for enlarging and projecting the image on the light modulating device onto a screen.

4. A projection type image display device comprising:
a reflector having a reflection surface of a spheroid as an inner surface thereof;
a light source, wherein at least a light emitting portion thereof is substantially planar, a light distribution thereof is within ±90° with respect to a normal line perpendicular to the plane, and the light emitting portion is located optically at a first focus of the spheroid forming the reflection surface of the reflector;
a condenser lens having a focus at a position of a second focus of the spheroid forming the reflection surface of the reflector;
a lens-array integrator provided in front of the condenser lens and including a set of microlenses;
a light modulating device illuminated by the lens-array integrator and capable of modulating an output of transmission light in accordance with an external signal; and
a projection optical system for enlarging and projecting the image on the light modulating device onto a screen.

5. The projection type image display device claim 1, wherein the light emitting portion of the light source is inclined toward a surface vertex of the reflection surface of the reflector with reference to a center axis of rotation of the reflection surface of the reflector.

6. The projection type image display device according to claim 5, wherein an angle θ between the normal line perpendicular to the plane of the light emitting portion of the light source and the center axis of rotation of the reflection surface of the reflector is in the range of 60≦θ≦90°.

7. The projection type image display device according to claim 1, wherein the center axis of rotation of the reflection surface of the reflector is inclined with respect to a system axis that is an optical axis common to optical parts excluding the reflector and the light source so that a light collection angle of light from the reflector is substantially symmetric with respect to the system axis.

8. The projection type image display device according to claim 2, wherein the center axis of rotation of the reflection surface of the reflector is shifted in parallel with a system axis that is an optical axis common to optical parts excluding the reflector and the light source so that a light collection angle of light from the reflector is substantially symmetric with respect to the system axis.

9. The projection type image display device according to claim 1, comprising a plurality of illumination units, each of which includes the reflector and the light source, and the plurality of reflectors are arranged symmetrically with respect to a system axis that is an optical axis common to optical parts excluding the illumination unit.

10. The projection type image display device according to claim 9, wherein the plurality of reflectors are arranged so that outer surfaces thereof are close to each other.

11. The projection type image display device according to claim 2, wherein the light emitting portion of the light source is inclined toward a surface vertex of the reflection surface of the reflector with reference to a center axis of rotation of the reflection surface of the reflector.

12. The projection type image display device according to claim 3, wherein the light emitting portion of the light source is inclined toward a surface vertex of the reflection surface of the reflector with reference to a center axis of rotation of the reflection surface of the reflector.

13. The projection type image display device according to claim 4, wherein the light emitting portion of the light source is inclined toward a surface vertex of the reflection surface of the reflector with reference to a center axis of rotation of the reflection surface of the reflector.

14. The projection type image display device according to claim 4, wherein the center axis of rotation of the reflection surface of the reflector is inclined with respect to a system axis that is an optical axis common to optical parts excluding the reflector and the light source so that a light collection angle of light from the reflector is substantially symmetric with respect to the system axis.

15. The projection type image display device according to claim 3, wherein the center axis of rotation of the reflection surface of the reflector is shifted in parallel with a system axis that is an optical axis common to optical parts excluding the reflector and the light source so that a light collection angle of light from the reflector is substantially symmetric with respect to the system axis.

16. The projection type image display device according to claim 2, comprising a plurality of illumination units, each of which includes the reflector and the light source, and the plurality of reflectors are arranged symmetrically with respect to a system axis that is an optical axis common to optical parts excluding the illumination unit.

17. The projection type image display device according to claim 3, comprising a plurality of illumination units, each of which includes the reflector and the light source, and the plurality of reflectors are arranged symmetrically with respect to a system axis that is an optical axis common to optical parts excluding the illumination unit.

18. The projection type image display device according to claim 4, comprising a plurality of illumination units, each of which includes the reflector and the light source, and the plurality of reflectors are arranged symmetrically with respect to a system axis that is an optical axis common to optical parts excluding the illumination unit.
